(19) United States
(12) Patent Application Publication
(10) Pub. No.: US 2025/0223978 A1
(43) Pub. Date: Jul. 10, 2025

(54) Piston Accumulator

(71) Applicant: Hydac Technology GmbH, Sulzbach / Saar (DE)

(72) Inventors: Norbert Weber, Saarsbrücken (DE); Yannik Zimmer, St. Wendel/Saal (DE); Sven Mann, Püttlingen (DE)

(73) Assignee: Hydac Technology GmbH, Sulzbach / Saar (DE)

(21) Appl. No.: 18/724,238

(22) PCT Filed: Dec. 21, 2022
(86) PCT No.: PCT/EP2022/087228

§ 371 Date: Jun. 26, 2024

(30) Foreign Application Priority Data
Jan. 18, 2022 (DE) 10 2022 000 176.4

(51) Int. Cl. F15B 1/24

(52) U.S. Cl. CPC F15B 1/24; F15B 2201/205; F15B 2201/31; F15B 2201/411

(57) ABSTRACT

The disclosure relates to a piston accumulator having an accumulator housing in which a separating piston is longitudinally movably guided which separates two fluid chambers, in particular separates a fluid chamber having a working gas from a further fluid chamber having an operating fluid, such as hydraulic oil, and which separating piston has a damping device, wherein, in addition to the damping device, an inflow device is provided which interacts with the damping device for damping a fluid flow out of the accumulator housing by forming a throttle along a fluid path and which releases a further fluid path by bypassing the other fluid path that has the throttle in order for fluid to flow into the accumulator housing.

### CROSS-REFERENCE TO RELATED APPLICATIONS

This application claims priority to German Patent Application No. DE 10 2022 000 176.4, filed on Jan. 18, 2022 with the German Patent and Trademark Office. The contents of the aforesaid patent application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a piston accumulator having an accumulator housing in which a separating piston is guided so as to be longitudinally movable, which separating piston separates two fluid chambers from each other, in particular separates a fluid chamber having a working gas from a further fluid chamber having an operating fluid, such as hydraulic oil, and which separating piston has a damping device.

EP 0 286 777 A2 discloses a generic piston-cylinder unit with piston end position damping which has a damping piston protruding from the end face of the piston, which damping piston can be retracted into a damping chamber provided at the facing cylinder end, forming a damping gap which tapers conically towards the fluid port, and a flow path is provided for initiating a return stroke movement of the piston, which leads from the fluid port for pressure oil, bypassing the damping gap, to the pressure chamber adjacent to the main piston surface of the piston in the accumulator housing and contains a check valve. This flow path, which can be controlled by the check valve, extends within the piston between an inlet opening at the front end of the damping piston, which is configured as a hollow sleeve, and an aperture leading from the interior of this sleeve to the outside in the form of a transverse channel. The check valve used in this respect has a solid valve plate which can be controlled by an energy accumulator in the form of a compression spring that controls a large opening cross-section in the damping piston, which results in leaks in the closed position and is accompanied by turbulence in the flow pattern when the valve is open. Furthermore, rapid opening and closing processes are excluded due to the inertia behaviour of the valve plate.

### SUMMARY

A need exists to provide a piston accumulator with improved end position damping for the separating piston in addition to improved response behaviour when fluid flows into or out of the hydraulic accumulator.

The need is addressed by the subject matter of the independent claim(s). Embodiments of the invention are described in the dependent claims, the following description, and the drawings.

### BRIEF DESCRIPTION OF THE DRAWINGS

FIG. 1 shows an example lower part of a piston accumulator in the manner of a longitudinal section, as illustrated by way of example in EP 0 286 777 A2; and

FIG. 2 shows an example diagram corresponding to FIG. 1 but in an open piston position and without the illustration of a piston fastening.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a piston accumulator is provided. In addition to the damping device there is also an inflow device which cooperates with the damping device for damping a fluid flow out of the accumulator housing by forming a throttle along a fluid path, and which releases a further fluid path by bypassing the one fluid path that has the throttle in order for fluid to flow into the accumulator housing. This means that when the piston accumulator is discharged, the separating piston is reliably damped up to its possible stop position on parts of the accumulator housing, such as a housing cover, and in the opposite direction of movement of the separating piston when the accumulator is being charged and operating fluid flows into the further fluid chamber, the inflow device opens, bypassing the one fluid path that has the throttle, as a result of which the entire piston cross-section responds directly when acted upon by fluid of a predefinable pressure and causes the separating piston to move against the precharge pressure of the working gas in the other fluid chamber. In this way, high dynamics are achieved for the return movement of the separating piston during an accumulator charging process.

If the damping device is completely disengaged from the inflow device during the further return movement of the separating piston towards the fluid chamber with the working gas, the fluid cross-section released in this way additionally allows fluid to flow into the further fluid chamber, which helps to further accelerate the charging process for the accumulator.

Therefore, the solution not only achieves improved damping behaviour during discharging of the piston accumulator, but also improved, unobstructed return flow during the accumulator charging process during which the separating piston is to be moved against the precharge pressure of the working gas in the one fluid chamber.

In some embodiments, it is provided that the damping device has a damping piston on the separating piston and that the inflow device has an inflow piston which is movably guided in parts of the accumulator housing. Due to the low mass inertia of the damping piston and the inflow piston, the fluid flows occurring in each case during charging and discharging of the piston accumulator can be reliably controlled in rapid succession, so that even piston accumulators which have to withstand a high number of load changes at quite high fluid pressures are improved during the charging and discharging processes compared to prior art solutions.

In some embodiments, it is provided that, for a damping process, the damping piston engages in a recess in the inflow piston, forming a throttle gap as the throttle in the one fluid path. In this case, the throttle gap is a cylindrical annular space with variable volume, formed from adjacent wall parts of the damping and inflow pistons. In this way, a constant throttle gap width is achieved over the entire engagement length of the damping piston in the inflow piston which results in significantly improved end position damping. Since, as shown in the cited prior art, there is no need to take account of any continuously changing gap geometry with conical sections, the engagement length for the damping piston can be selected to be extremely long within predefinable limits due to the geometry to be maintained for the piston accumulator, so that significantly improved end position damping of the piston is achieved in conjunction with the constant gap dimension over the entire engagement length.

In some embodiments, it is provided that the inflow piston is accommodated in a housing cover as part of the accumulator housing and is inserted into a fluid port which establishes a fluid connection to the further fluid chamber having the operating fluid via the respective fluid path. In this way, both the damping device and the inflow device with their respective flow paths to be controlled are accommodated in the housing cover in a space-saving manner and, due to the design selected, the aforementioned arrangement can also be retrofitted to existing piston accumulators of conventional type and in this way improve them in damping behaviour and inflow behaviour.

In some embodiments, it is provided that the inflow piston is supported in the housing cover in an axially displaceable manner by means of a circlip in such a way that in a lowered position the further fluid path is blocked and in a raised position this fluid path is released. Due to the circlip fastening, both the damping device and the inflow device can be fixed to the free end face of the separating piston in an extremely easy-to-install manner and can be accommodated together in a fluid port in the adjacent housing cover in the one end position of the separating piston, the fluid port establishing a fluid connection between the further fluid chamber, between the separating piston and the housing cover, and a conventional hydraulic circuit with its components which can be connected to the fluid port by means of piping.

In some embodiments, it is provided that the inflow piston is inserted into an enlarged cross-section in the housing cover in such a manner that a cylindrical flow chamber is created between the cylindrical outer circumference of the inflow piston and the adjacent opposing inner circumference of the housing cover as part of the further fluid path. It is for example further provided that, on its end face directed away from the separating piston, the inflow piston is provided with a crowned contact surface which can be brought into contact with a conical support surface in the housing cover, forming a valve seat. Thanks to the partially crowned valve seat, an articulated bearing with clearance for the inflow piston on the separating piston is achieved even when using the circlip guide, for the purpose of tolerance compensation between the separating piston, including its seal and a guide band, and the adjacently arranged wall or casing parts of the accumulator housing, in particular including the associated housing cover. For improved valve seat geometry, it is also possible to provide the free end face of the inflow piston, which is directed away from the separating piston, in a hexagonal design or with a “spot face”.

For secure guidance of the damping piston in the inflow piston, it is for example provided that in any case when the piston accumulator is in the fully discharged state, the damping piston engages completely through the inflow piston and in the process for example engages with an at least partially conical end part as an insertion aid into the inflow piston until it reaches an overhang at the edge.

The disclosure further relates to a method for operating a piston accumulator, as described above, comprising the following method steps:
Throttling of the volumetric flow during discharging of the piston accumulator by forming a hollow cylindrical throttle gap between a damping device and an inflow device.
Bypassing the throttle gap during charging of the piston accumulator by opening the inflow device, and as a result
Admitting fluid pressure to the entire free cross-section of a separating piston for directly displacing the separating piston towards a fluid chamber having a working gas.

The piston accumulator is discussed in greater detail below with reference the drawings. Specific references to components, process steps, and other elements are not intended to be limiting.

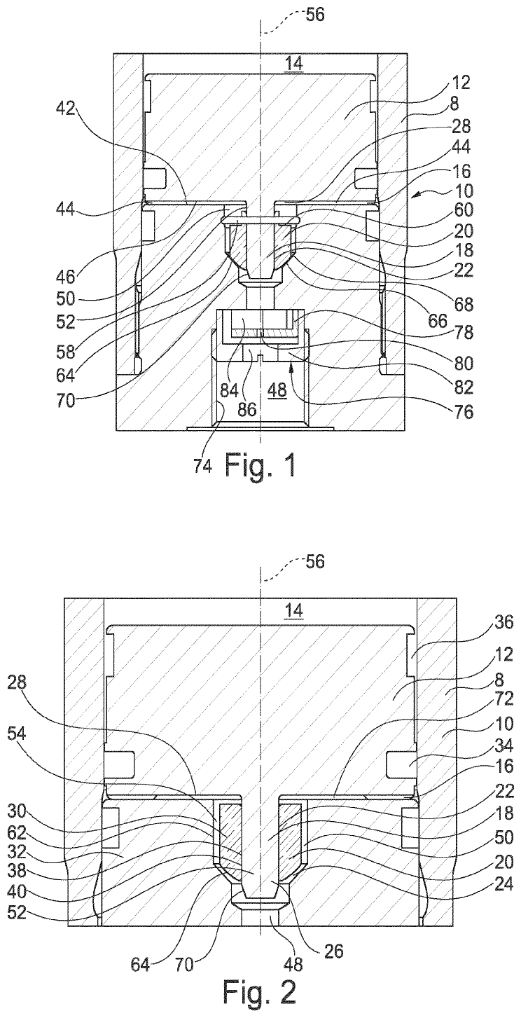

FIG. 1 shows the lower part of a piston accumulator having a hollow cylindrical wall part 8 of an accumulator housing denoted as a whole by 10, in which a separating piston 12 is guided so as to be longitudinally movable, which separating piston separates two fluid chambers 14, 16 from each other, in particular a fluid chamber 14 having a working gas, such as nitrogen, from a further fluid chamber 16 having an operating fluid, such as hydraulic oil.

In addition, the separating piston 12 has a damping device 18 integrally connected to it on its free end-face end. Furthermore, there is an inflow device 20 which cooperates with the damping device 18 for damping a fluid flow out of the accumulator housing 10 by forming a throttle along a fluid path 22, according to the simplified diagram shown in FIG. 2, and which releases a further fluid path 24 by bypassing the one fluid path 22 that has the throttle in order for fluid to flow into the accumulator housing 10.

As FIGS. 1 and 2 further show, the damping device 18 has a damping piston 26 which, for example connected integrally to the separating piston 12, is arranged centrally on the free lower end face 28 of the separating piston 12. In addition, the inflow device 20 has an inflow piston 30 which is movably guided in parts of the accumulator housing 10, here in the form of a housing cover 32. The said housing cover 32, as part of the accumulator housing 10, is screwed into the bottom of the hollow cylindrical wall part 8 thereof and sealed with respect to the rest of the accumulator housing 10 via a ring seal, which is not shown is greater detail. The separating piston 12 itself has two annular grooves 34, 36 on the outer circumference for receiving sealing rings and guide bands, which are not shown in greater detail.

For a damping process, the damping piston 26 moves from an upper position into a cylindrical recess 38 (FIG. 2) in the inflow piston 30, forming a throttle gap 40 as the throttle in the one first fluid path 22 formed in this respect. This displacement movement of the separating piston 12 from top to bottom towards the liquid side of the accumulator is completed when, as shown in the diagram of FIG. 1, the end face 28 of the separating piston 12 comes at least partially into contact with the top side 42 of the housing cover 32. Individual stop members 44 distributed around the circumference on the end face 28 of the separating piston 12 are used as limit stops for the end face 28. According to the diagram of FIGS. 1 and 2, an annular gap 46 is thus formed between the flat end face 28 of the separating piston 12 and the top side 42 of the housing cover 32, except for the stop members 44 which come to a stop, said annular gap acting as an additional damping gap and, in a damping function, displacing fluid from the further, second fluid chamber 16 towards the throttle gap 40, formed from the adjacent wall parts of the damping piston 26 and the inflow piston 30. In the aforementioned discharging position of the accumulator, the operating fluid displaced in this manner from the fluid chamber 16 is directed towards a fluid port 48, via which the accumulator can be connected to a hydraulic working circuit by means of conventional piping (not shown). In this respect, the accumulator for the discharging process is kept depressurised on the side of the fluid port 48 and the separating piston 12 moves to its end position shown in the FIGS. under the precharge pressure of the working gas in the fluid chamber 14.

The inflow piston 30 is accommodated in a receiving space 50 in the lower housing cover 32 as part of the accumulator housing 10 and in this respect, as already explained, is inserted into the fluid port 48 which establishes a fluid connection to the further fluid chamber 16 having the operating fluid via the respective fluid path 22, 24, and via a third fluid path 52, which emerges when the damping piston 26 together with the upwards movement of the separating piston 12 in an accumulator charging position disengages completely from the hollow cylindrical recess 38 in the inflow piston 30 due to the return stroke movement of the separating piston 12 under the fluid pressure at the fluid port 48.

Before the damping piston 26 accordingly disengages from the inflow piston 30, the latter is first lifted axially upwards via the fluid pressure in the fluid port 48 as shown in the diagram of FIG. 2, the outer circumferential side of the damping piston 26 forming a cylindrical partial guide for this purpose. Therefore, as shown in the diagram of FIG. 2, the inflow piston 30 is raised by the fluid pressure in the fluid port 48 and releases the second fluid path 24 in such a manner that more fluid reaches the free end face 28 of the separating piston 12 and the latter is raised together with the damping piston 26 under the fluid pressure in the fluid chamber 14, against the precharge pressure of the working gas. In this way, a fluid connection 54 is established to the further fluid chamber 16 having the operating fluid in any case, according to the diagram of FIG. 2, via the second fluid path 24.

Both the separating piston 12 and the two pistons 26, 30, as well as the fluid port 48 in the lower housing cover 32 are arranged concentric with one another and coaxial with a longitudinal axis 56 of the accumulator housing 10. To enable the inflow piston 30 to move from its closed position as shown in FIG. 1 to an open passage position as shown in FIG. 2 and vice versa, it is mounted in the housing cover 32 by means of a flexible circlip 58 (shown only in FIG. 1) so that it can move axially. For this purpose, the circlip 58 engages on the outer circumference in an associated inner groove in the housing cover 32 and on the inner circumference it is penetrated by a contact shoulder 60 which is only shown in FIG. 1 and which, in the raised position of the inflow piston 30 shown in FIG. 2, comes into contact with the inner circumference of the circlip 58 and can otherwise emerge downwards from the circlip 58 by a predefinable distance, according to the diagram in FIG. 1. In any case, the circlip 58 makes it possible in this way for the further fluid path 24 to be blocked in a lowered position of the inflow piston 30 (FIG. 1) and for this fluid path 24 to be released in an opposed, raised position (FIG. 2). For the aforementioned function, the inflow piston 30 is in any case inserted into an enlarged cross-section 62 in the housing cover 32, forming the fluid connection 54, in such a manner that a flow chamber, which in this respect is cylindrical, is created between the cylindrical outer circumference of the inflow piston 30 and the adjacent opposing inner circumference of the housing cover 32 for establishing the fluid connection 54.

On its end face directed away from the separating piston 12, the inflow piston 30 has a crowned, in particular convex, contact surface 64 which can be brought into contact with a corresponding conical support surface 68 in the housing cover 32, forming a kind of valve seat 66 (FIG. 1). Due to the crowned design, self-adjustment is thus achieved for the inflow piston 30 towards the said valve seat 66 on the housing cover 32. This also ensures centring for the separating piston 12, provided that it enters the corresponding, hollow cylindrical recess 38 in the inflow piston 30 by means of the cylindrical damping piston 26, with increasing enlargement of the throttle gap 40.

In the fully discharged state according to the diagram of FIG. 1, the damping piston 26 has then completely penetrated the inflow piston 30 and the damping piston 26 protrudes at least partially with a conical end part 70 over the edge of the inflow piston 30, the end slope being formed in this way on the damping piston 26 allowing unobstructed engagement in the inflow piston 30, with associated downwards movement of the separating piston 12 as part of a discharge process on the liquid side of the hydraulic or piston accumulator.

Insofar as the description refers to orientations such as “top” and “bottom”, this refers to a standard operating mode of the piston accumulator in vertical alignment.

In any case, the piston accumulator shown in FIGS. 1 and 2 is moved in such a manner that at least the following method steps are implemented:
Throttling of the volumetric flow during discharging of the piston accumulator by forming the hollow cylindrical throttle gap 40 between the damping piston 26 and the inflow piston 30, the associated downwards movement of the separating piston 12 displacing fluid from the fluid chamber 16 via the throttle gap 40 towards the fluid port 48 which is kept depressurised.

Further throttling takes place through the annular gap 46 as a damping gap between the free end face 28 of the separating piston 12 and the adjacent opposite top side 42 of the housing cover 32.
Bypassing the aforementioned throttle or damping gaps 40, 46 when charging the piston accumulator by opening the further fluid connection 24 by lifting the inflow piston 30 from its valve seat 66 out of the closed position according to FIG. 1 into the open position according to FIG. 2. Due to the resulting pressure difference, in this way fluid under pressure enters the piston fluid chamber 72 between the separating piston 12 and the housing cover 32 via the fluid port 48, the separating piston 12 lifting upwards, viewed in the direction of the FIGS., as a result and, with further displacement movement against the precharge pressure of the working gas in the fluid chamber 14, the volume of liquid on the liquid side of the accumulator that has the fluid chamber 16 increases visibly. If, during the aforementioned upwards movement of the separating piston 12, the central recess 38 is released by extending the damping piston 26 out of the inflow piston 30, a further, third fluid path 52 is released so that fluid of a predefinable pressure can flow directly into the piston fluid chamber 72 via the fluid port 48. As a result, fluid pressure subsequently acts on the entire free cross-section of the piston for direct movement of the separating piston 12 towards the other fluid chamber 14 having the working gas.
In this way, an accumulator charging process usually takes place and, once the operating cycle has been completed, the piston accumulator is available again for the discharging process described.

In the diagram of FIG. 1, a damping valve denoted as a whole by 76 is provided in the region of an internal thread 74 of the fluid port 48, which valve has a longitudinally displaceable valve plate 78 in which a throttle bore 80 is introduced coaxial with the longitudinal axis 56 of the piston accumulator. The aforementioned valve plate 78 is accommodated in a valve housing 82, for example configured as tripod, which is screwed flush into the associated fluid port 48 along the internal thread 74. Since there is a fluid inlet 84 between each of the legs of the valve housing 78, in the position shown, fluid can flow in from the hydraulic working circuit via the fluid port 48 at a predefinable pressure towards the fluid chamber 16 via a bottom-side inlet 86 in the valve housing 78 to charge the accumulator when the inflow device 20 is open. Conversely, i.e. when discharging the accumulator, the valve plate 78 moves from its upper travel position shown in FIG. 1 to a lower closed position, in which the valve plate 78 rests on the inside of the valve housing 82 and a fluid passage is then only provided via the throttle bore 80 in the valve plate 78, so that throttling of the fluid flow is also implemented in this respect by the damping valve 76 in addition to the throttling measures 40 and/or 46 already described. Further details on the function and construction of the aforementioned damping valves also emerge by way of example from DE 103 37 744 B3.

Piston accumulators of this type, as presented, regularly have a high precharge pressure which generates large forces on the separating piston 12 and its sealing system, particularly during rapid discharging below the gas precharge pressure. When the piston reaches the end position shown in FIGS. 1 and 2, shock-like loads then act on the separating piston 12 and the associated piston seal. This in turn means that the gas pressure present constantly presses the seal abruptly against the groove flank directed towards the hydraulic oil in the annular groove 34 in the separating piston 12. These dynamics in the sealing system and the accompanying settling effects of the seal in the annular groove 34 lead to increased gas loss from the piston accumulator. In addition, the hard metal impacts between the separating piston 12 and the housing cover 3 are acoustically disturbing and, in extreme cases, mechanical damage relating to this can also occur in this region.

The hydraulic end position damping, as presented, ensures that the separating piston 12 moves to its end position shown in FIG. 1 at reduced speed. However, this also reduces the abrupt load on the sealing system, which can effectively reduce gas losses and overall wear on the accumulator. This thus has no equivalent in prior art. The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-10. (canceled)

11. A piston accumulator having an accumulator housing in which a separating piston is guided so as to be longitudinally movable, which separating piston separates two fluid chambers from each other and which separating piston has a damping device, wherein, in addition to the damping device, there is an inflow device which cooperates with the damping device for damping a fluid flow out of the accumulator housing by forming a throttle along a fluid path, and which releases a further fluid path by bypassing the one fluid path that has the throttle in order for fluid to flow into the accumulator housing.

12. The piston accumulator of claim 11, wherein the damping device has a damping piston on the separating piston and wherein the inflow device has an inflow piston which is movably guided in parts of the accumulator housing.

13. The piston accumulator of claim 12, wherein, for a damping process, the damping piston engages in a recess in the inflow piston, forming a throttle gap as the throttle in the one fluid path.

14. The piston accumulator of claim 13, wherein the throttle gap is a cylindrical annular space with variable volume, formed from adjacent wall parts of the damping and inflow pistons.

15. The piston accumulator of claim 12, wherein the inflow piston is accommodated in a housing cover as part of the accumulator housing and is inserted into a fluid port which establishes a fluid connection to the further fluid chamber having the operating fluid via the respective fluid path.

16. The piston accumulator of claim 15, wherein the inflow piston is supported in the housing cover in an axially displaceable manner using a circlip in such a way that in a lowered position the further fluid path is blocked and in a raised position this fluid path is released.

17. The piston accumulator of claim 15, wherein the inflow piston is inserted into an enlarged cross-section in the housing cover in such a manner that a cylindrical flow chamber is created between the cylindrical outer circumference of the inflow piston and the adjacent opposing inner circumference of the housing cover.

18. The piston accumulator of claim 15, wherein, on its end face directed away from the separating piston, the inflow piston is provided with a crowned contact surface which can be brought into contact with a conical support surface in the housing cover, forming a valve seat.

19. The piston accumulator of claim 11, wherein, in its fully discharged state, the damping piston engages completely through the inflow piston.

20. A method for operating a piston accumulator of one of the preceding claims, comprising:
throttling of the volumetric flow during discharging of the piston accumulator by forming a hollow cylindrical throttle gap between a damping device and an inflow device;
bypassing the throttle gap during charging of the piston accumulator by opening the inflow device, and as a result;
admitting fluid pressure to the entire free cross-section of a separating piston for directly displacing the separating piston towards a fluid chamber having a working gas.

21. The piston accumulator of claim 11, wherein the separating piston separates a fluid chamber having a working gas from a further fluid chamber having an operating fluid.

22. The piston accumulator of claim 21, wherein the operating fluid is a hydraulic oil.

23. The piston accumulator of claim 19, wherein the damping piston protrudes over the edge of the inflow piston with an at least partially conical end part.

24. The method of claim 20, wherein the damping device has a damping piston on the separating piston and wherein the inflow device has an inflow piston which is movably guided in parts of the accumulator housing.

25. The method of claim 24, wherein, for a damping process, the damping piston engages in a recess in the inflow piston, forming a throttle gap as the throttle in the one fluid path.

26. The method of claim 25, wherein the throttle gap is a cylindrical annular space with variable volume, formed from adjacent wall parts of the damping and inflow pistons.

27. The method of claim 24, wherein the inflow piston is accommodated in a housing cover as part of the accumulator housing and is inserted into a fluid port which establishes a fluid connection to the further fluid chamber having the operating fluid via the respective fluid path.

28. The method of claim 27, wherein the inflow piston is supported in the housing cover in an axially displaceable manner using a circlip in such a way that in a lowered position the further fluid path is blocked and in a raised position this fluid path is released.

29. The method of claim 27, wherein the inflow piston is inserted into an enlarged cross-section in the housing cover in such a manner that a cylindrical flow chamber is created between the cylindrical outer circumference of the inflow piston and the adjacent opposing inner circumference of the housing cover.

30. The method of claim 27, wherein, on its end face directed away from the separating piston, the inflow piston is provided with a crowned contact surface which can be brought into contact with a conical support surface in the housing cover, forming a valve seat.
